(19) United States
(12) Patent Application Publication
(10) Pub. No.: US 2006/0267921 A1
(43) Pub. Date: Nov. 30, 2006

(54) Method of and apparatus for forming image according to brightness distribution of image data

(75) Inventors: Hyo-jin Kim, Seoul (KR); Myong-hun Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/431,016

(22) Filed: May 10, 2006

(30) Foreign Application Priority Data
May 11, 2005 (KR) 10-2005-0039234

(51) Int. Cl. G09G 3/36

(52) U.S. Cl. 345/102

(57) ABSTRACT

Provided are an apparatus for and method of forming an image according to a brightness distribution of image data. The method includes detecting a brightness distribution of an image data unit that represents image data of a page unit; determining whether the image of the image data unit is formed or not according to the detected brightness distribution; stopping the image formation for the image data unit if the image formation is not formed; and executing the image formation for the image data unit if the image formation is determined. Therefore, toner waste generated when an image of excessively low brightness is printed due to a user's mistake or a incorrect operation of the image forming apparatus can be prevented.

### CROSS-REFERENCE TO RELATED PATENT APPLICATIONS

This application claims the benefit under 35 U.C.S. §119(a) of Korean Patent Application No. 10-2005-0039234, filed on May 11, 2005, in the Korean Intellectual Property Office, the entire disclosure of which is hereby incorporated by reference.

### BACKGROUND OF THE INVENTION

1. Field of the Invention

The present invention relates to image formation. More particularly, the present invention relates to a method of and apparatus for forming an image according to brightness distribution in image data in order to prevent unnecessary use of toner.

2. Description of the Related Art

An image forming apparatus such as a copying machine or a multi-functional apparatus may waste toner when performing an incorrect operation due to a user's mistake. For example, a printing operation of a copying machine should be performed after placing a document on a flat bed, however, if printing is performed in a state where the document is not placed on the flat bed or a cover is open, an image of low brightness, that is, a black image is printed on a sheet of paper. Thus, a large amount of toner is wasted, and accordingly, a method of preventing waste of toner is necessary.

### SUMMARY OF THE INVENTION

The present invention provides a method of and apparatus for forming an image according to brightness distribution of image data in order to prevent waste of toner due to a user's mistake or a wrong operation of the apparatus.

The present invention also provides a method of and apparatus for forming an image according to brightness distribution of image data that prevent waste of toner by controlling brightness of an image of low brightness.

According to an aspect of the present invention, there is provided a method of forming an image according to brightness distribution of image data. The method includes detecting a brightness distribution of an image data unit that represents image data of a page unit. Whether the image of the image data unit is formed or not according to the detected brightness distribution is determined.I Image formation for the image data unit is stopped if the image formation is determined to be stopped. Image formation for the image data unit is executed if the image formation proceeds.

According to another aspect of the present invention, there is provided an apparatus for forming an image according to a brightness distribution of image data. The apparatus includes a brightness distribution detector for detecting a brightness distribution of an image data unit that represents image data in a page unit. An image formation determiner determines whether an image for the image data unit is formed or not according to the detection result of the brightness distribution detector. A controller outputs a control signal requesting the image formation for the image data unit to be stopped or a control signal requesting the image formation for the image data unit to be executed according to the determination result of the determiner. An image forming unit stops the image formation for the image data unit or executes the image formation according to the control signal of the controller.

### BRIEF DESCRIPTION OF THE DRAWINGS

The above and other features and advantages of exemplary embodiments of the present invention will become more apparent from the following detailed description in connection with the attached drawings in which:

FIG. 1 is a flow chart illustrating a method of forming an image according to brightness distribution of image data according to an exemplary embodiment of the present invention;

FIG. 2 is a flow chart illustrating an example of step 10 in FIG. 1;

FIG. 3 is a histogram of the image data of FIG. 1;

FIG. 4 is a flow chart illustrating an example of step 12 in FIG. 1;

FIG. 5 is a flow chart illustrating a method of forming an image according to a brightness distribution of image data according to another exemplary embodiment of the present invention;

FIG. 6 is a flow chart illustrating an example of step 50 in FIG. 5;

FIG. 7 is a flow chart illustrating an example of step 52 in FIG. 5;

FIG. 8 is a block diagram of an apparatus for forming an image according to brightness distribution of image data according to an exemplary embodiment of the present invention;

FIG. 9 is a block diagram of a brightness distribution detecting unit of FIG. 8;

FIG. 10 is a block diagram of an image forming determination unit of FIG. 8;

FIG. 11 is a block diagram of an apparatus for forming an image according to brightness distribution of image data according to another exemplary embodiment of the present invention;

FIG. 12 is a block diagram of a brightness distribution detecting unit of FIG. 11; and

FIG. 13 is a block diagram of a brightness control determination unit of FIG. 11.

Throughout the drawings, like reference numbers should be understood to refer to like elements, features and structures.

### DETAILED DESCRIPTION OF EXEMPLARY EMBODIMENTS

FIG. 1 is a flow chart illustrating a method of forming an image according to brightness distribution of image data according to an exemplary embodiment of the present invention.

Referring to FIG. 1, brightness distribution of a unit of image data representing image data of a page unit, is detected at step 10. The image data unit refers to document data of a page.

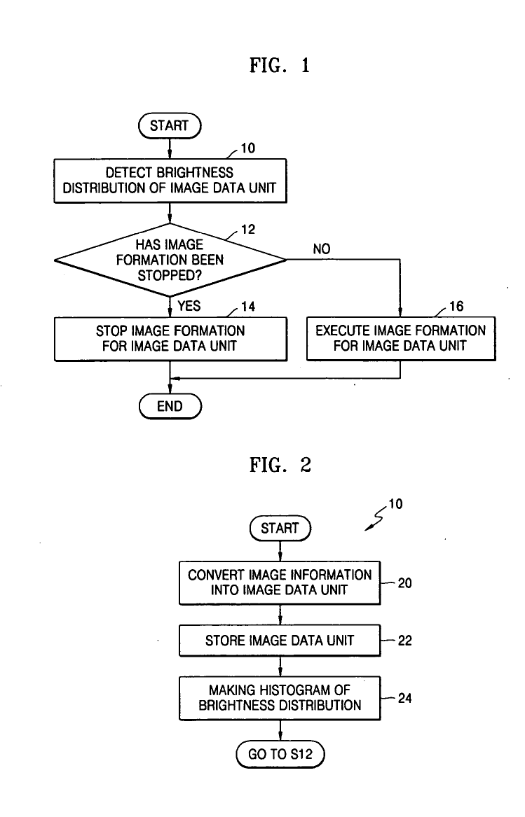

FIG. 2 is a flow chart illustrating the operation of step 10 of FIG. 1.

The image information corresponding to an analog signal is converted into the image data unit corresponding to a digital signal at step 20. The image information corresponding to the analog signal is input by a charge coupled device (CCD). The CCD is an element that changes the external light into electric charges, accumulates the electric charges, and transmits the accumulated electric charges. For example, a copying machine includes a CCD for converting image information into digital data, and thus, the copying machine can perform the operation of step 20. However, since a printer does not include a CCD, the printer does not perform the operation of step 20. Therefore, the operation of step 20 is preferably performed by an image forming apparatus including a CCD, and the image forming apparatus that does not include a CCD does not perform the operation of step 20.

After performing the operation of step 20, the image data unit is stored in a predetermined storage space. The image data unit may be obtained by converting the image information through the operation of step 20, or may be directly input as digital data. The image data unit is temporarily stored in a predetermined storage space.

After performing the operation of step 22, pixels of the stored image data unit are classified based on the brightness values, and detected as a histogram classified according to the same brightness value for pixels of the stored image data unit as the brightness distribution at step 24.

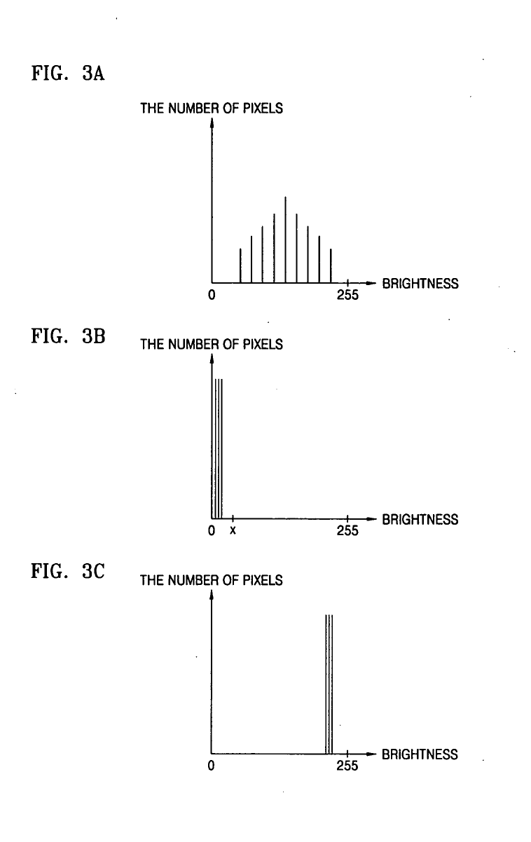

FIGS. 3A-3C are exemplary histograms of the image data unit. Referring to FIGS. 3A-3C, brightness is divided into 256 levels. FIG. 3A is a histogram similar to a normal distribution curve when the pixels of the image data unit are classified based on the same brightness value, and FIG. 3B is a histogram where the bar graphs are concentrated on low brightness values when the pixels of the image data unit are classified based on the same value, that is, the image data unit includes most of the pixels having low brightness values. In addition, FIG. 3C is a histogram where the bar graphs are concentrated on high brightness values when the pixels of the image data unit are classified based on the same value, that is, the image data unit includes most of the pixels having high brightness value.

After performing the operation at step 10, whether image formation of the image data unit is determined or not according to the detected brightness distribution at step 12.

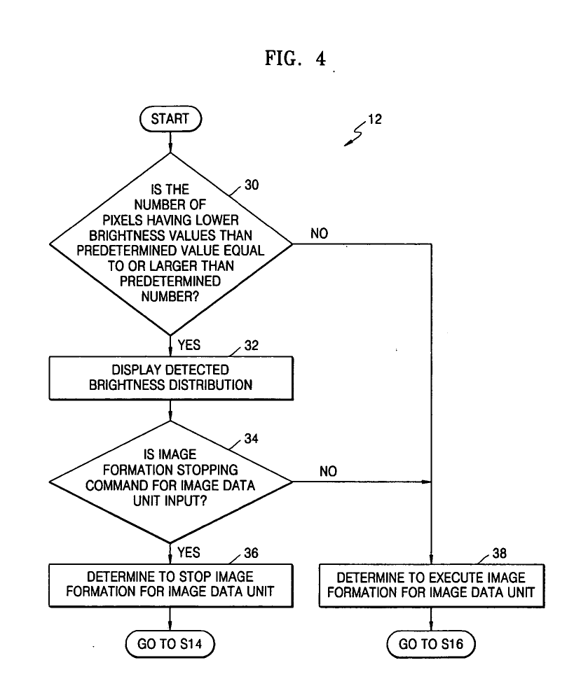

FIG. 4 is a flow chart illustrating the operation at step 12 of FIG. 1.

At step 30, it is detected whether a number of pixels of the image data unit having lower brightness values than a predetermined value is larger than a predetermined number of pixels from the brightness distribution. For example, if the predetermined brightness value is x as shown in FIG. 3B, it is detected how many pixels having the brightness values lower than x are included among the pixels forming the image data unit.

If the number of pixels having the brightness values lower than the predetermined value is less than the predetermined number, toner is not wasted when the image data unit is printed, and thus, the operation at step 38 is performed.

However, if the number of pixels having the brightness values lower than the predetermined value is larger than the predetermined number, the detected brightness distribution is displayed at step 32. When the number of pixels having the brightness value lower than the predetermined value is smaller than the predetermined number, the toner may be wasted when an image corresponding to the image data unit is formed, and thus, the brightness distribution of the image data unit is displayed so that a user can recognize it.

The detected brightness may be displayed, or quantified information of the brightness distribution (for example, the number of pixels responding to each of brightness value) can be displayed. In addition, the image information of the image data unit can be displayed besides the detected brightness distribution.

After performing step 32, whether an image formation stopping command of the image data unit is input or not is checked at step 34. The user identifies the displayed brightness distribution or the image information of the image data unit, and determines whether the image of the image data unit is formed or not. The image formation stopping command is a command for suspending the image formation. If the image formation stopping command for the image data unit is not input, the image corresponding to the image data unit can be formed, and thus, the operation at step 38 is performed. However, if the image formation stopping command is input, the image formation corresponding to the image data unit is stopped at step 36.

If the number of pixels having the brightness value lower than the predetermined value is less than the predetermined number in step 30, or if the image formation stopping command of the image data unit is not input in step 34, execution of image formation for the image data unit is determined at step 38.

The above described operations (steps 32 and 34) are not essential in embodiments of the present invention. Therefore, in the operation at step 30, if the number of pixels having the brightness value lower than the predetermined value is the predetermined number or larger, the operation at step 36 is performed without performing steps 32 and 34, and if the number of the pixels having the brightness values lower than the predetermined value is smaller than the predetermined number, the operation at step 38 is performed without performing steps 32 and 34.

If the image formation is determined to be stopped in the operation at step 12, the image formation for the image data unit is stopped at step 14. Therefore, a toner waste generated by an incorrect operation of the apparatus or a user's mistake can be prevented in advance.

However, if image formation is not determined to be stopped in the operation at step 12, the image for the image data unit is formed at step 16. That is, the image data unit is correct data, and thus, the image for the image data unit is formed.

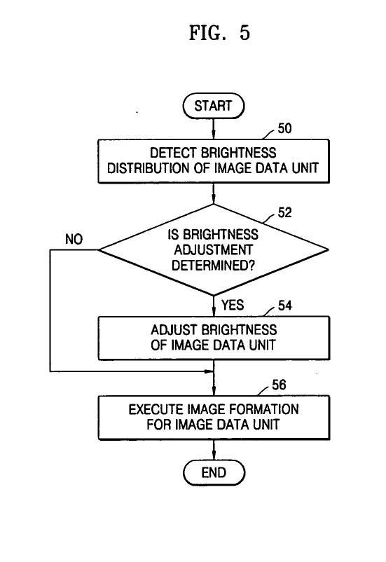

FIG. 5 is a flow chart illustrating another example of a method of forming the image according to the brightness distribution according to an exemplary embodiment of the present invention.

First, the brightness distribution of the image data unit representing image data for a page unit is detected at step 50.

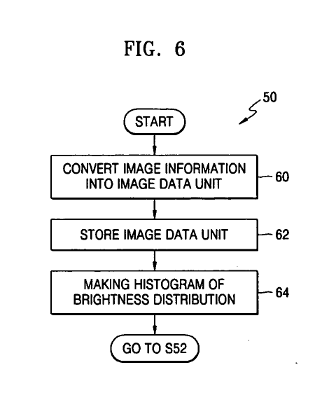

FIG. 6 is a flow chart illustrating the operation at step 50 of FIG. 5. The image information corresponding to an analog signal is converted into an image data unit corresponding to a digital signal at step 60. The operation at step 60 is performed by an image forming apparatus including a CCD, and an image forming apparatus that does not include a CCD does not perform the operation at step 60.

After the operation at step 60, the image data unit is stored in a predetermined storage space at step 62. The image data unit may be obtained by converting the image information through the operation at step 60, or may be directly input as digital data. The image data unit is temporarily stored in a predetermined storage space.

After performing the operations at step 62, pixels of the stored image data unit are classified-based on the brightness values, and detected a histogram classified according to the same brightness value for pixels of the stored image data unit as the brightness distribution at step 64. Referring to FIG. 3, brightness is divided into 256 levels. The brightness distribution is represented as a histogram according to the number of pixels having the same brightness values.

After the operation at step 50, it is determined whether the brightness of the image data unit is adjusted or not according to the brightness distribution at step 52.

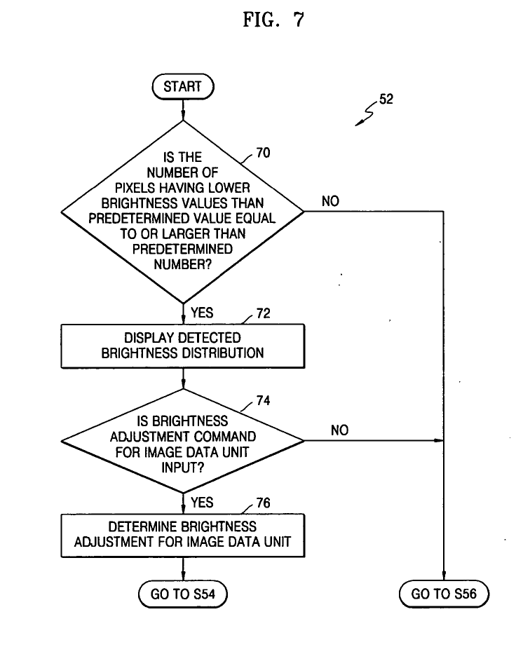

FIG. 7 is a flow chart illustrating the operation at step 52 of FIG. 5.

Whether a number of pixels having lower brightness values than a predetermined value is larger than a predetermined number of pixels from the brightness distribution is detected at step 70. For example, if the predetermined brightness value is x as shown in FIG. 3B, how many pixels having the brightness values lower than x are included among the pixels forming the image data unit is determined.

If the number of pixels of the image data unit having the brightness values lower than the predetermined value is less than the predetermined number, toner is not wasted when the image data unit is printed, and thus, the operation at step 56 is performed.

However, if the number of pixels having the brightness values lower than the predetermined value is larger than the predetermined number, the detected brightness distribution is displayed at step 72. When the number of pixels having the brightness value lower than the predetermined value is smaller than the predetermined number, the toner may be wasted when the image corresponding to the image data unit is formed, and thus, the brightness distribution of the image data unit is displayed so that a user can recognize it.

The detected brightness may be displayed, or quantified information of the brightness distribution (for example, the number of pixels responding to each of brightness value) can be displayed. In addition, the image information of the image data unit can be displayed besides the detected brightness distribution.

After performing the operation at step 72, it is checked whether a brightness adjustment command of the image data unit is input or not at step 74. Then, a user identifies the displayed brightness distribution or the image information of the image data unit, and determines whether the brightness of the image data unit is adjusted or not. The brightness adjustment command is a command requesting the brightness adjustment of the image data unit.

If the brightness adjustment command for the image data unit is not input, the image corresponding to the image data unit can be formed, and thus, the operation at step 56 is performed. However, if the brightness adjustment command is input, the image formation corresponding to the image data unit is stopped at step 76.

The above described operations (steps 72 and 74) are not essential in embodiments of the present invention. Therefore, in the operation at step 70, if the number of pixels having the brightness value lower than the predetermined value is equal to or larger than the predetermined number, the operation at step 76 is performed without performing the operations at steps 72 and 74, and if the number of the pixels having the brightness values lower than the predetermined value is smaller than the predetermined number, the operation at step 56 may be performed without performing the operations at steps 72 and 74.

If the brightness is determined to be adjusted in step 52, the brightness of the image data unit is adjusted at step 54. In particular, the brightness of the entire unit image signal is increased. For example, if the brightness value of the image data unit is excessively low as shown in FIG. 3B, the brightness of the image data unit is increased toward the high brightness value as shown in FIG. 3C. Therefore, the toner waste can be reduced by improving the brightness.

After steps 52 or 54, the image for the image data unit, the brightness of which is adjusted, is formed at step 56. Therefore, the amount of toner used to form the image can be reduced.

On the other hand, the method of exemplary embodiments of the present invention can be performed through a program, which can be performed in a computer, and can be realized in a general-purpose digital computer, which operates the program using a recording medium readable by the computer. That is, the method of exemplary embodiments of the present invention can be performed through codes or instructions or a program, which can be performed in a computer, and can be realized in a general-purpose digital computer, which operates the codes or instructions or program using a recording medium readable by the computer. The computer-readable recording medium includes a storage medium such as a magnetic storing medium (for example, a ROM, a floppy disk, and a hard disk), an optical read-out medium (for example, a CD-ROM, DVD), and a carrier wave (for example, transmission through internet). In addition, exemplary embodiments of the present invention can be realized as media including computer readable codes, and thus, a plurality of computer systems connected to each other by a network can separately process. The programs, codes, and code segments realizing exemplary embodiments of the present invention can be construed easily by programmers knowledgeable in the art.

Hereinafter, an apparatus for forming an image according to brightness distribution of image data according to an exemplary embodiment of the present invention will be described in detail with reference to accompanying drawings.

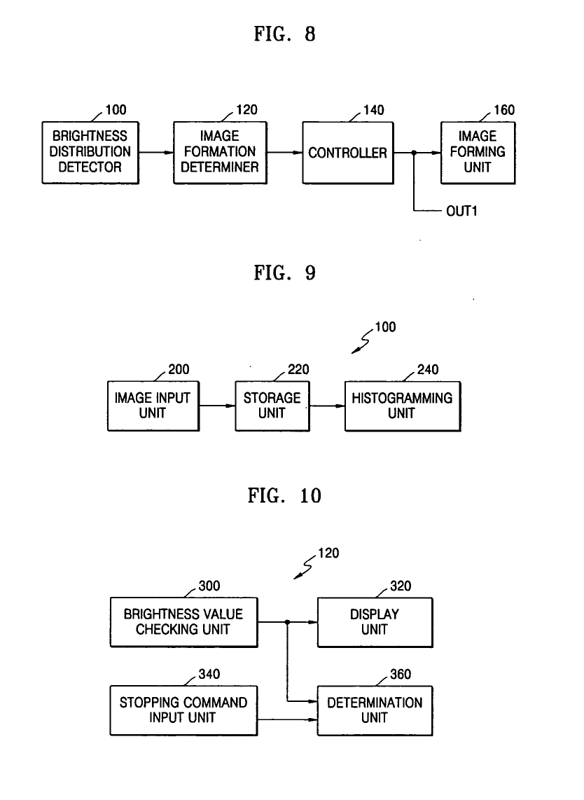

FIG. 8 is a block diagram of the image forming apparatus according to the brightness distribution of the image data, the apparatus including a brightness distribution detector 100, an image formation determiner 120, a controller 140, and an image forming unit 160.

The brightness distribution detector 100 detects the brightness distribution of an image data unit representing the document data of a page unit, and outputs the detection result to the image formation determiner 120.

FIG. 9 is a block diagram of the brightness distribution detector 100 of FIG. 8, the brightness distribution detector 100 including an image input unit 200, a storage unit 220, and a histogramming unit 240.

The image input unit 200 converts the image information corresponding to an analog signal into an image data unit corresponding to a digital signal. The image input unit 200 includes a CCD to change optical information of the image information into electrical charges, and transmits the electrical charges. The image input unit 200 converts the image information input through the CCD into a digital signal. The image input unit 200 is not an essential element of embodiments of the present invention, and thus, can be omitted.

The storage unit 220 temporarily stores the image data unit and outputs the data into the histogramming unit 240. The image data unit stored in the storage unit 220 may be obtained by converting the image information received by the image input unit 200, or directly input as digital data from a host.

The histogramming unit 240 detects a histogram classified according to the same brightness value for pixels of the stored image data unit as the brightness distribution. As shown in FIG. 3, the brightness distribution is obtained by classifying the pixels according to the brightness values.

The image formation determiner 120 determines whether the image corresponding to the image data unit is formed or not according to the detection result of the brightness distribution detector 100, and outputs the determination result to the controller 140.

FIG. 10 is a block diagram of the image formation determiner 120 of FIG. 8, the image formation determiner 120 includes a brightness value checking unit 300, a display unit 320, a stopping command input unit 340, and a determination unit 360.

The brightness value checking unit 300 checks whether the number of pixels having brightness values lower than the predetermined value is larger than the predetermined number, and outputs the checking result to the display unit 320 and the determination unit 360. For example, if the predetermined brightness value is x as shown in FIG. 3B, the brightness value checking unit 300 checks the number of pixels having lower brightness value than x among the pixels of the image data unit.

The display unit 320 displays the detected brightness distribution according to the checking result of the brightness value checking unit 300. When the checking result that the number of pixels having lower brightness level than the predetermined level is equal to or larger than the predetermined number is input from the brightness value checking unit 300, the display unit 320 displays the detected brightness distribution so that the user can recognize it.

The display unit 320 displays the quantified information of the detected brightness distribution. In addition, the display unit 320 displays the image information of the image data unit besides the detected brightness distribution.

The stopping command input unit 340 checks whether the image formation stopping command for the image data unit is input, and outputs the checking result to the determination unit 360. The stopping command input unit 340 displays a user interface (such as a dialog box) so that the user can input the image formation stopping command. The stopping command input unit 340 checks whether the user inputs the image formation stopping command through the user interface. Since the stopping command input unit 340 is not an essential element in the apparatus, the determination unit 360 operates by the checking result of the brightness value checking unit 300 when the stopping command input unit 340 does not exist.

The determination unit 360 determines to stop the image formation of the image data unit or to execute the image formation according to the checking result of the brightness value checking unit 300 or the stopping command input unit 340. That is, if the checking result that the number of pixels having the brightness value lower than the predetermined value is equal to or larger than the predetermined number is input from the brightness value checking unit 300, the determination unit 360 determines to stop the image formation of the corresponding image data unit. In addition, if the checking result that the image formation stopping command is input is received from the stopping command input unit 340, the determination unit 360 determines to stop the image formation for the corresponding image data unit. However, if the checking result that the number of pixels having a lower brightness value than the predetermined value is not larger than the predetermined number is input from the brightness value checking unit 300, the determination unit 360 determines to execute the image formation for the image data unit.

The controller 140 outputs a control signal for suspending the image formation of the image data unit to the image forming unit 160, or outputs a control signal for executing the image formation for the image data unit to the image forming unit 160 according to the determination result of the image formation determiner 120.

The image forming unit 160 stops or executes the image formation for the corresponding image data unit according to the control signal of the controller 140.

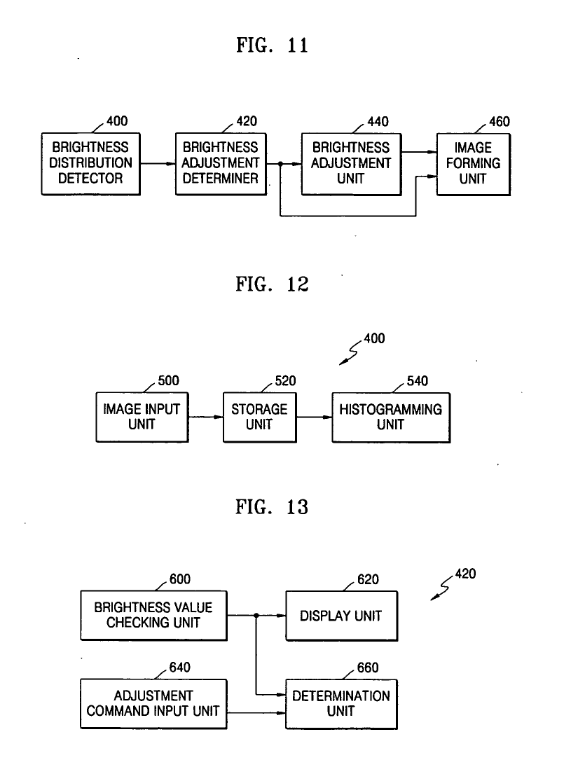

FIG. 11 is a block diagram of an image forming apparatus according to the brightness distribution of image data according to another exemplary embodiment of the present invention. The pparatus includes a brightness distribution detector 400, a brightness adjustment determiner 420, a brightness adjustment unit 440, and an image forming unit 460.

The brightness distribution detector 400 detects the brightness distribution of an image data unit representing image data of a page unit, and outputs the detection result to the image formation determiner 420.

FIG. 12 is a block diagram of the brightness distribution detector 400 of FIG. 11. The brightness distribution detector 400 includes an image input unit 500, a storage unit 520, and a histogramming unit 540.

The image input unit 500 converts the image information corresponding to an analog signal into an image data unit corresponding to a digital signal. The image input unit 500 includes a CCD to change optical information of the image information into electrical charges, and transmits the electrical charges. The image input unit 500 converts the image information input through the CCD into a digital signal. The image input unit 200 is not an essential element of exemplary embodiments of the present invention, and thus, can be omitted.

The storage unit 520 temporarily stores the image data unit and outputs the data into the histogramming unit 540. The image data unit stored in the storage unit 520 may be obtained by converting the image information received by the image input unit 500, or directly input as digital data from a host.

The histogramming unit 540 detects a histogram classified according to the same brightness value for pixels of the stored image data unit as the brightness distribution. As shown in FIG. 3, the brightness distribution is obtained by classifying the pixels according to the brightness values.

The brightness adjustment determiner 420 determines whether the brightness of the image data unit is adjusted or not according to the detection result of the brightness distribution detector 400, and outputs the determination result to the brightness adjustment unit 440 and the image forming unit 460.

FIG. 13 is a block diagram of the brightness adjustment determiner 420 of FIG. 10. The brightness adjustment determiner 420 includes a brightness value checking unit 600, a display unit 620, an adjustment command input unit 640, and a determination unit 660.

The brightness value checking unit 600 checks whether the number of pixels having a brightness values lower than the predetermined value is larger than the predetermined number, and outputs the checking result to the display unit 620 and the determination unit 660. For example, if the predetermined brightness value is x as shown in FIG. 3B, the brightness value checking unit 600 checks the number of pixels having lower brightness value than x among the pixels of the image data unit.

The display unit 620 displays the detected brightness distribution according to the checking result of the brightness value checking unit 600. When according to the checking result the number of pixels having lower brightness level than the predetermined level is equal to or larger than the predetermined number is input from the brightness value checking unit 600, the display unit 620 displays the detected brightness distribution so that the user can recognize it.

The display unit 620 displays the quantified information of the detected brightness distribution. In addition, the display unit 620 displays the image information of the image data unit besides the detected brightness distribution.

The adjustment command input unit 640 checks whether the image formation stopping command for the image data unit is input, and outputs the checking result to the determination unit 660. The brightness adjusting command is a command requesting to adjust the brightness of the image. The adjustment command input unit 640 displays a user interface (such as a dialog box) so that the user can input the image formation stopping command. The adjustment command input unit 640 checks whether the user inputs the brightness adjustment command through the user interface. Since the adjustment command input unit 640 is not an essential element in the apparatus, the determination unit 660 operates by checking a result of the brightness value checking unit 600 when the adjustment command input unit 640 does not exist.

The determination unit 660 determines to adjust the brightness of the image data unit according to the checking result of the brightness value checking unit 600 or the adjustment command input unit 640. That is, if the checking result that the number of pixels having the brightness value lower than the predetermined value is equal to or larger than the predetermined number is input from the brightness value checking unit 600, the determination unit 660 determines to adjust the brightness of the image data unit. In addition, if the checking result that the image formation stopping command is input is received from the stopping command input unit 640, the determination unit 660 determines to adjust the brightness of the image data unit, and outputs the determination result to the brightness adjustment unit 440. However, if the checking result that the number of pixels having lower brightness value than the predetermined value is not larger than the predetermined number is input from the brightness value checking unit 600, the determination unit 660 determines to execute the image formation for the image data unit without adjusting the brightness of the image data unit, and outputs the determination result to the image forming unit 460.

The brightness adjustment unit 440 adjusts the brightness of the image data unit according to the determination result of the brightness adjustment determination unit 420, and outputs the adjusted result to the image forming unit 460. In particular, the brightness adjustment unit 440 increases the brightness of the entire image data unit. For example, in a case where the brightness value of the image data unit is excessively low as shown in the histogram of FIG. 3B, the brightness adjustment unit 440 improves the brightness entirely as shown in the histogram of FIG. 3C.

The image forming unit 160 executes the image formation corresponding to the image data unit according to the determination result of the brightness adjustment determination unit 420 or the adjusted result of the brightness adjustment unit 440.

According to the image forming apparatus and method according to the brightness distribution of the image data of exemplary embodiments of the present invention, toner waste generated when an image of low brightness is printed due to a wrong operation of the apparatus or a mistake of a user can be prevented in advance.

In addition, the image data having low brightness can be improved, and thus, an image having high brightness can be printed, and accordingly, the toner waste can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of forming an image according to brightness distribution of image data, the method comprising the operations of:
detecting a brightness distribution of an image data unit that represents image data of a page unit;
determining whether to form the image of the image data unit according to the detected brightness distribution;
stopping the image formation for the image data unit if the image formation is determined to be stopped; and
executing the image formation for the image data unit if the image formation is determined.

2. The method of claim 1, wherein the step of detecting a brightness distribution includes the operations of:
storing the image data unit; and
detecting a histogram classified according to the same brightness value for pixels of the stored image data unit as the brightness distribution.

3. The method of claim 2, wherein the step of detecting a brightness distribution further includes an operation of converting image information corresponding to an analog signal into the image data unit corresponding to a digital signal.

4. The method of claim 1, wherein the determining step includes the operations of:
checking whether a number of pixels of the image data unit having lower brightness values than a predetermined value is equal to or larger than a predetermined number based on the brightness distribution;
determining that the image formation is to be stopped if the number of pixels having the lower brightness values than the predetermined value is equal to or larger than the predetermined number; and
determining that the image formation is to be executed if the number of pixels is not larger than the predetermined number.

5. The method of claim 4, wherein the determining step further includes the operations of:
displaying the detected brightness distribution when the number of pixels having the lower brightness values than the predetermined value is equal to or larger than the predetermined number in the checking process; and
checking whether an image formation stopping command for the image data unit is input,
wherein when the image formation stopping command for the image data unit is input, the operation of determining the image formation to be stopped is performed, and when the image formation stopping command for the image data unit is not input, the operation of determining the image formation to be executed is performed.

6. The method of claim 5, wherein in the displaying step, quantified information of the detected brightness distribution is displayed.

7. The method of claim 5, wherein in the displaying step, image information of the image data unit is displayed besides the detected brightness distribution.

8. A computer readable recording medium having embodied thereon a computer program for executing the method of claim 1.

9. A method of forming an image according to a brightness distribution of image data, the method comprising the steps of:
detecting a brightness distribution of an image data unit that represents image data of a page unit;
determining whether to adjust the brightness of the image data unit according to the detected brightness distribution;
adjusting the brightness of the image data unit if adjusting for the brightness of the image data unit is determined; and
executing image formation for the image data unit having the brightness adjusted.

10. The method of claim 9, wherein the detecting step further comprises:
storing the image data unit; and
detecting a histogram classified according to the same brightness value for pixels of the stored image data unit as the brightness distribution.

11. The method of claim 10, wherein the detecting step further comprises converting the image information corresponding to an analog signal into an image data unit corresponding to a digital signal.

12. The method of claim 9, wherein the determining step comprises:
checking from the brightness distribution whether a number of pixels of the image data unit having lower brightness values than a predetermined value is equal to or larger than a predetermined number; and
adjusting the brightness of the image data unit if the number of pixels having the lower brightness values than the predetermined value is equal to or larger than the predetermined number.

13. The method of claim 12, wherein the image formation step further comprises:
displaying the detected brightness distribution when the number of pixels having the lower brightness value than the predetermined value is equal to or larger than the predetermined number in the checking process; and
checking whether a brightness adjustment command for the image data unit is input,
wherein when the brightness adjustment command for the image data unit is input, the operation of adjusting the brightness is performed.

14. The method of claim 13, wherein in the step of displaying of brightness distribution, quantified information of the detected brightness distribution is displayed.

15. The method of claim 13, wherein in the step of displaying of brightness distribution, image information of the image data unit is displayed besides the detected brightness distribution.

16. The method of claim 9, wherein the brightness adjustment is performed by improving the brightness of the entire image data unit.

17. A computer readable recording medium having embodied thereon a computer program for executing the method of claim 9.

18. An apparatus for forming an image according to a brightness distribution of image data, the apparatus comprising:
a brightness distribution detector for detecting a brightness distribution of an image data unit that represents image data in a page unit;
an image formation determiner for determining whether an image for the image data unit is formed or not according to the detection result of the brightness distribution detector;
a controller for outputting a control signal requesting image formation for the image data unit to be stopped or a control signal requesting image formation for the image data unit to be executed according to the determination result of the determiner; and
an image forming unit for stopping the image formation for the image data unit or executing the image formation according to the control signal of the controller.

19. The apparatus of claim 18, wherein the brightness distribution detector comprises:
a storage unit for storing the image data unit; and
a histogramming unit for detecting a histogram classified according to the same brightness value for pixels of the stored image data unit as the brightness distribution.

20. The apparatus of claim 19, wherein the brightness distribution detector further comprises an image input unit for converting image information corresponding to an analog signal into an image data unit corresponding to a digital signal.

21. The apparatus of clam 18, wherein the image formation determiner includes:
a brightness value checking unit for checking a number of pixels of the image data unit having brightness values lower than a predetermined value among the pixels of the image data unit from the detected brightness distribution; and
a determination unit for determining whether the image formation for the image data unit is to be stopped or executed according to the checking result of the brightness value checking unit.

22. The apparatus of claim 21, wherein the image formation determiner further comprises:
a display unit for displaying the detected brightness distribution according to the checking result of the brightness value checking unit; and
a stopping command input unit for checking whether an image formation stopping command for the image data unit is input or not.

23. The apparatus of claim 22, wherein the display unit displays quantified information of the detected brightness distribution.

24. The apparatus of claim 22, wherein the display unit displays image information of the image data unit besides the brightness distribution.

25. An apparatus for forming an image according to a brightness distribution of image data, the apparatus comprising:
a brightness distribution detector for detecting a brightness distribution of an image data unit that represents image data of a page unit;
a brightness adjustment determiner for determining whether a brightness of the image data unit is adjusted or not according to the detection result of the brightness distribution detector;
a brightness adjustment unit for adjusting the brightness of the image data unit according to the determination result of the brightness adjustment determiner; and
an image forming unit for executing the image formation according to the adjusted result of the brightness adjustment unit.

26. The apparatus of claim 25, wherein the brightness distribution detector comprises:
a storage unit for storing the image data unit; and
a histogramming unit for detecting a histogram classified according to the same brightness value for pixels of the stored image data unit as the brightness distribution.

27. The apparatus of claim 26, wherein the brightness distribution detector further comprises an image input unit for converting image information corresponding to an analog signal into an image data unit corresponding to a digital signal.

28. The apparatus of claim 25, wherein the brightness adjustment determiner comprises:
a brightness value checking unit for checking from the detected brightness distribution a number of pixels of the image data unit having brightness values lower than a predetermined value among the pixels of the image data unit; and
a determination unit for determining the brightness adjustment for the image data unit according to the checking result of the brightness value checking unit.

29. The apparatus of claim 29, wherein the brightness adjustment determiner further comprises:
a display unit for displaying the detected brightness distribution according to the checking result of the brightness value checking unit; and
an adjustment command input unit for checking whether a brightness adjustment command of the image data unit is input or not.

30. The apparatus of claim 29, wherein the display unit displays quantified information of the detected brightness distribution.

31. The apparatus of claim 29, wherein the display unit displays image information of the image data unit besides the brightness distribution.

32. The apparatus of claim 25, wherein the brightness adjustment unit improves the brightness of the entire image data unit.
